(19) United States
(12) Patent Application Publication
(10) Pub. No.: US 2022/0393711 A1
(43) Pub. Date: Dec. 8, 2022

(54) LOCAL OSCILLATOR CONTROL METHOD AND SYSTEM, SIGNAL TRANSCEIVING METHOD AND TERMINAL

(71) Applicant: ZTE Corporation, Shenzhen (CN)

(72) Inventor: Long LI, Shenzhen (CN)

(21) Appl. No.: 17/775,084

(22) PCT Filed: Dec. 10, 2020
(86) PCT No.: PCT/CN2020/135302

§ 371 Date: May 6, 2022

(30) Foreign Application Priority Data
Dec. 17, 2019 (CN) 201911302009.7

(51) Int. Cl. H04B 1/10

(52) U.S. Cl. CPC H04B 1/1027; H04B 2001/1072

(57) ABSTRACT

Disclosed are a local oscillator control method and system, a signal transceiving method, a terminal device, a non-transitory computer-readable storage medium and an electronic device. The local oscillator control method may include: in response to an operating resource of a scene being received and the operating resource containing a millimeter wave resource, extracting, from the operating resource, an operating frequency band in the scene; evaluating whether interference presents between the operating frequency band and a default frequency point of a millimeter wave intermediate-frequency signal; and in response to a presence of interference, acquiring a new frequency point of a local oscillator signal matched with an interference-free frequency point of an intermediate-frequency signal, and adjusting the frequency point of the local oscillator signal from a default frequency point of the local oscillator signal to the new frequency point.

### CROSS-REFERENCE TO RELATED APPLICATION

This application is a national stage filing under 35 U.S.C. § 371 of international application number PCT/CN2020/135302, filed Dec. 10, 2020, which claims priority to Chinese patent application No. 201911302009.7, filed Dec. 17, 2019. The contents of these applications are incorporated herein by reference in their entirety.

### TECHNICAL FIELD

The present disclosure relates to the technical field of communication, and in particular to a local oscillator control method and system, a signal transceiving method, a terminal device, a non-transitory computer-readable storage medium and an electronic device.

### BACKGROUND

With the further development of 5G industry, millimeter wave terminal devices will become popular. A double-conversion signal transceiving method is generally adopted in the existing millimeter wave terminal schemes. That is, baseband signals are firstly up-converted into intermediate-frequency (IF) signals, and the IF signals are then up-converted into radio frequency (RF) signals in millimeter wave frequency bands. According to the requirements for the rate of FR2 frequency bands in the 3GPP specification and the implementability of the circuit, the frequency of IF signals is generally selected within the range of 10 GHz or less. In the non-standalone (NSA) mode, LTE frequency bands may generate harmonic and intermodulation interference with millimeter wave IF signals; and in the NR CA mode, Sub-6G frequency modes may also generate harmonic and intermodulation interference with millimeter wave IF signals. Due to various frequency bands and complex frequency combinations, these interferences are often difficult to avoid. Therefore, how to resist interference becomes a technical problem to be solved urgently at present.

### SUMMARY

In order to solve at least one of the technical problems in the existing technology, the present disclosure provides a local oscillator control method and system, a signal transceiving method and a terminal device, which can adaptively adjust a frequency point of a local oscillator signal according to different scenes so as to avoid interference between an intermediate-frequency signal matched with this local oscillator signal and an operating frequency band in the current scene.

In order to achieve the above purpose, according to an embodiment of the present disclosure, provided is a local oscillator control method. The method may include: in response to an operating resource of a scene being received and the operating resource containing a millimeter wave resource, extracting, from the operating resource, an operating frequency band in the scene; evaluating whether interference presents between the operating frequency band and a default frequency point of a millimeter wave intermediate-frequency signal; and, in response to the presence of interference, acquiring a new frequency point of a local oscillator signal matched with an interference-free frequency point of an intermediate-frequency signal, and adjusting the frequency point of the local oscillator signal from a default frequency point of the local oscillator signal to the new frequency point.

According to another embodiment of the present disclosure, further provided is a signal transceiving method. The method may include: in response to a mainboard module receiving a baseband signal, mixing a first local oscillator signal with the baseband signal to form an intermediate-frequency signal; and, in response to the mainboard module receiving an intermediate-frequency signal, mixing the first local oscillator signal with the received intermediate-frequency signal to form a baseband signal; and, in response to a millimeter wave module receiving an intermediate-frequency signal transmitted by the mainboard module, mixing a second local oscillator signal with the intermediate-frequency signal to form a millimeter wave signal; and, in response to the millimeter wave module receiving a millimeter wave signal, mixing the second local oscillator signal with the millimeter wave signal to form an intermediate-signal signal. Frequency points of the first local oscillator signal and the second local oscillator signal are controlled by the local oscillator control method described above.

According to yet another embodiment of the present disclosure, further provided is a local oscillator control system. The system may include a central control unit and a local oscillator control unit. The central control unit is configured to: in response to an operating resource of a scene being received and the operating resource containing a millimeter wave resource, extract, from the resource, an operating frequency band in the scene, and evaluate whether interference presents between the operating frequency band and a default frequency point of a millimeter wave intermediate-frequency signal; and, in response to the presence of interference, acquire a new frequency point of a local oscillator signal matched with an interference-free frequency point of an intermediate-frequency signal, and control the local oscillator control unit to adjust the frequency point of the local oscillator signal from a default frequency point of the local oscillator signal to the new frequency point.

According to yet another embodiment of the present disclosure, further provided is a terminal device. The terminal device may include a mainboard module, an intermediate-frequency transmission line, a millimeter wave module and the local oscillator system provided by the present disclosure. The mainboard module and the millimeter wave module transmit intermediate-frequency signals through the intermediate-frequency transmission line. The local oscillator control system is configured to: in response to the mainboard module receiving a baseband signal, mix a first local oscillator signal with the baseband signal to form an intermediate-frequency signal; in response to the mainboard module receiving an intermediate-frequency signal, mix the first local oscillator signal with the received intermediate-frequency signal to form a baseband signal; in response to the millimeter wave module receiving an intermediate-frequency signal transmitted by the mainboard module, mix a second local oscillator signal with the intermediate-frequency signal to form a millimeter wave signal; and, in response to the millimeter wave module receiving a millimeter wave signal, mix the second local oscillator signal with the millimeter wave signal to form an intermediate-frequency signal.

According to yet another embodiment of the present disclosure, further provided is a non-transitory computer-readable storage medium configured to store executable programs which, when executed by a processor, cause the processor to carry out the local oscillator control method provided by the present disclosure or the signal transceiving method provided by the present disclosure.

According to yet another embodiment of the present disclosure, further provided is an electronic device. The electronic device may include: a storage module having first application programs and/or second application programs stored thereon; and, one or more first processors. The first application programs, when executed by the one or more first processors, cause the one or more first processors to carry out the local oscillator control method provided by the present disclosure, and the second application programs, when executed by the one or more first processors, cause the one or more first processors to carry out the signal transceiving method provided by the present disclosure.

### BRIEF DESCRIPTION OF DRAWINGS

FIG. 1 is a flowchart of a local oscillator control method according to a first embodiment of the present disclosure;

FIG. 2 is a flowchart of a local oscillator control method according to a second embodiment of the present disclosure;

FIG. 3 is another flowchart of the local oscillator control method according to the second embodiment of the present disclosure;

FIG. 4 is a schematic block diagram of a local oscillator control system according to a third embodiment of the present disclosure;

FIG. 5 is a schematic block diagram of a terminal according to a fourth embodiment of the present disclosure;

FIG. 6 is a connection diagram of an intermediate-frequency transmission line according to the fourth embodiment of the present disclosure;

FIG. 7 is a schematic diagram of the transceiving process of an intermediate-frequency signal according to the fourth embodiment of the present disclosure; and

FIG. 8 is a schematic diagram of the transceiving process of a radio frequency signal according to the fourth embodiment of the present disclosure.

### DETAILED DESCRIPTION

In order to make those having ordinary skills in the art better understand the technical schemes of the present disclosure, the local oscillator control method and system, the signal transceiving method and the terminal provided by the present disclosure will be described below in detail with reference to the accompanying drawings.

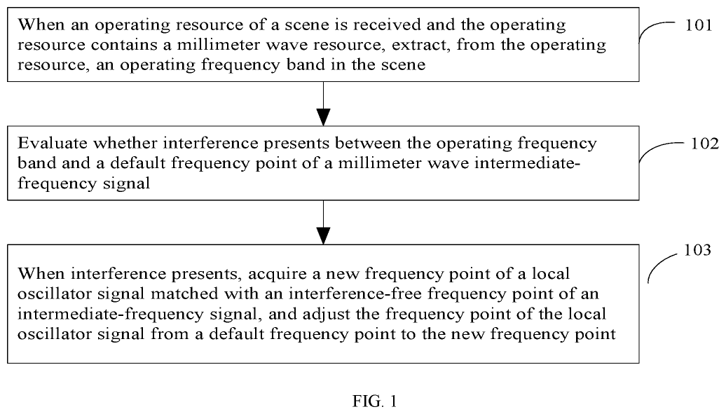

With reference to FIG. 1, a first embodiment of the present disclosure provides a local oscillator control method. The method may include steps S101 to S103.

At S101, when an operating resource of a scene is received and a millimeter wave resource is contained in the operating resource, an operating frequency band for the scene is extracted from the operating resource.

For example, the operating frequency band is an LTE frequency band in the EN-DC mode, a frequency point of a non-millimeter wave NR signal in the NR CA mode, and the like.

S101 plays a role in intelligently identifying a current scene.

At S102, an evaluation is made on whether interference presents between the operating frequency band and a default frequency point of a millimeter wave intermediate-frequency signal; and, if yes, S103 will be executed.

At S103, a new frequency point of a local oscillator signal matched with an interference-free frequency point of an intermediate-frequency signal is acquired, and the frequency point of the local oscillator signal is adjusted from a default frequency point of the local oscillator signal to the new frequency point.

At S103, the intermediate-frequency signal obtained by up-mixing the local oscillator signal utilizing the new frequency point with a baseband signal or the intermediate-frequency signal obtained by down-mixing the local oscillator signal utilizing the new frequency point with a millimeter wave signal will not interfere with the operating frequency band in the current scene. Thus, in accordance with the local oscillator control method provided in this embodiment, a dynamic adjustment of the frequency point of the local oscillator signal can be realized, so that the frequency point of the local oscillator signal can be adaptively adjusted for different scenes to avoid interference between the intermediate-frequency signal matched with the local oscillator signal and the operating frequency band in the current scene.

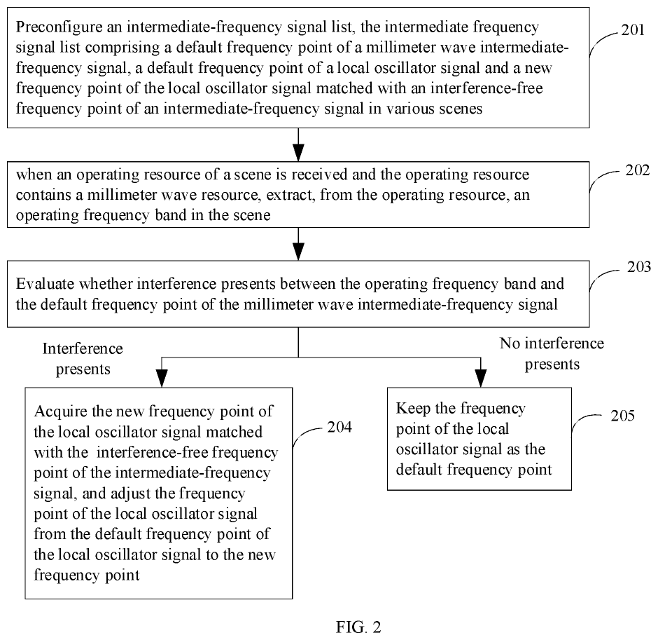

With reference to FIG. 2, a second embodiment of the present disclosure provides a local oscillator control method. The method may include steps S201 to S205.

At S201, an intermediate-frequency signal list is preconfigured, where the intermediate-frequency signal list includes a default frequency point of a millimeter wave intermediate-frequency signal, a default frequency point of a local oscillator signal and a new frequency point of the local oscillator signal matched with an interference-free frequency point of an intermediate-frequency signal in various scenes.

During the configuration process of the intermediate-frequency signal list, all supported scenes related to the millimeter wave frequency band will be evaluated according to the software and hardware conditions of the terminal device, and the most commonly used intermediate-frequency signal configuration is comprehensively selected as a default configuration. The intermediate-frequency signal configuration contains the default frequency point of the millimeter wave intermediate-frequency signal and the default frequency point of the local oscillator signal. Meanwhile, the new frequency point of the local oscillator signal matched with the interference-free frequency point of the intermediate-frequency signal in various scenes is comprehensively calculated, and an intermediate-frequency signal configuration index corresponding to each scene is obtained by mapping.

In an embodiment, the scene includes a dual connection (EN-DC) mode or a new radio carrier aggregation (NR CA) mode of a 4G radio access network and 5G new radio, and the like.

At S202, when an operating resource of a scene is received and a millimeter wave resource is contained in the operating resource, an operating frequency band in the scene is extracted from the operating resource.

For example, the operating frequency band is an LTE frequency band in the EN-DC mode, or a frequency point of a non-millimeter wave NR signal in the NR CA mode.

At S203, an evaluation is made on whether interference presents between the operating frequency band and the default frequency point of the millimeter wave intermediate-frequency signal; if yes, S204 will be executed; and, if no, S205 will be executed.

At S204, a new frequency point of the local oscillator signal matched with the interference-free frequency point of the intermediate-frequency signal is acquired, and the frequency point of the local oscillator signal is adjusted from the default frequency point of the local oscillator signal to the new frequency point.

At S205, the frequency point of the local oscillator signal is kept as the default frequency point.

At S204, the local oscillator signal utilizing the new frequency point is subjected to frequency conversion, so that the intermediate-frequency signal obtained by frequency conversion will not interfere with the operating frequency band in the current scene. Thus, in accordance with the local oscillator control method provided in this embodiment, a dynamic adjustment of the frequency point of the local oscillator signal can be realized, so that the frequency point of the local oscillator signal can be adaptively adjusted for different scenes to avoid interference between the intermediate-frequency signal matched with the local oscillator signal and the operating frequency band in the current scene.

During the execution of S204, the new frequency point of the local oscillator signal corresponding to the current scene can be selected from the intermediate-frequency signal configuration index according to this scene. Of course, in practical applications, the new frequency point of the local oscillator signal can also be obtained by any other methods, which will not be limited by the embodiment.

With reference to FIG. 3, in an embodiment, the local oscillator control method according to the second embodiment of the present disclosure includes steps S301 to S307.

At S301, an operating resource allocated by a base station network is received.

At S302, whether the operating resource contains a millimeter wave resource is determined; if yes, S203 will be executed; and, if no, S208 will be executed.

At S303, an operating frequency band in a scene is extracted from the operating resource.

At S304, whether interference presents between the operating frequency band and a default frequency point of a millimeter wave intermediate-frequency signal is evaluated; if yes, S305 will be executed; and, if no, S306 will be executed.

At S305, a new frequency point of a local oscillator signal matched with an interference-free frequency point of an intermediate-frequency signal is acquired, and the frequency point of the local oscillator signal is adjusted from a default frequency point of the local oscillator signal to the new frequency point.

At S306, the frequency point of the local oscillator signal is kept as the default frequency point.

At S307, waiting for receiving a new resource allocated by the base station network (the new resource is changed relative to the original operating resource) is performed.

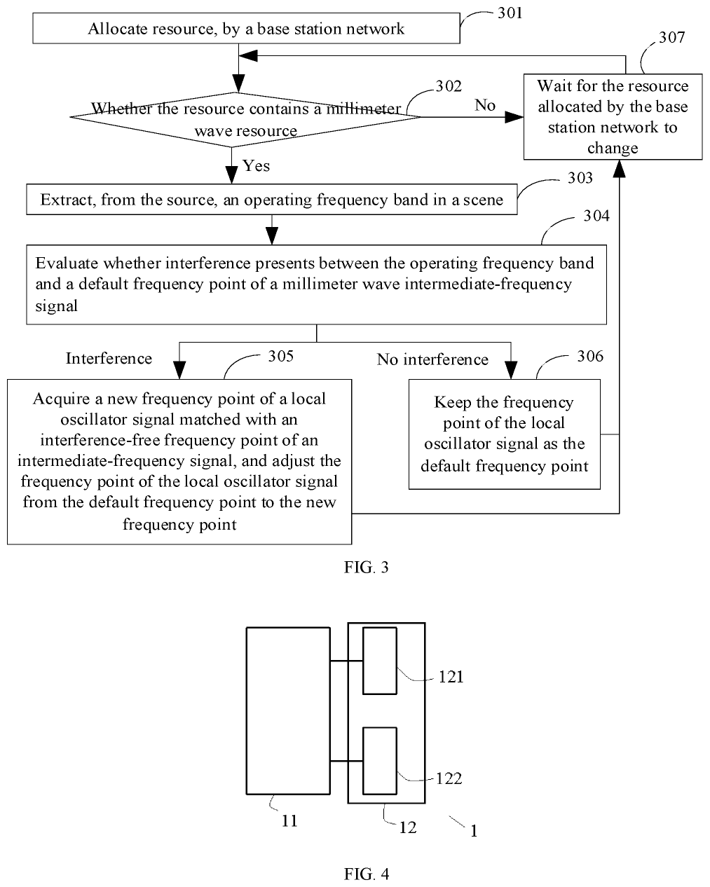

With reference to FIG. 4, according to a third embodiment of the present disclosure, provided is a local oscillator control system 1. The system 1 may include a central control unit 11 and a local oscillator control unit 12. When an operating resource of a scene is received and the operating resource contains a millimeter wave resource, the central control unit 11 is configured to extract, from the operating resource, an operating frequency band in the scene, and evaluate whether interference presents between the operating frequency band and a default frequency point of a millimeter wave intermediate-frequency signal.

If interference presents, the central control unit 11 acquires a new frequency point of a local oscillator signal matched with an interference-free frequency point of an intermediate-frequency signal, and controls the local oscillator control unit 12 to adjust the frequency point of the local oscillator signal from a default frequency point of the local oscillator signal to the new frequency point.

If no interference presents, the central control unit 11 controls the local oscillator control unit 12 to adjust and keep the frequency point of the local oscillator signal as the default frequency point.

In accordance with the local oscillator control system 1 provided in this embodiment, a dynamic adjustment of the frequency point of the local oscillator signal can be realized, so that the frequency point of the local oscillator signal can be adaptively adjusted for different scenes to avoid interference between the intermediate-frequency signal matched with the local oscillator signal and the operating frequency band in the current scene.

In this embodiment, the local oscillator control unit 12 includes a first sub-unit 121 and a second sub-unit 122. The first sub-unit 121 is configured to adjust a frequency point of a first local oscillator signal under the control of the central control unit 11, mix the first local oscillator signal with a baseband signal received by a mainboard module to form an intermediate-frequency signal, and mix the first local oscillator signal with an intermediate-frequency signal received by the mainboard module to form a baseband signal.

The second sub-unit 122 is configured to adjust a frequency point of a second local oscillator signal under the control of the central control unit 11, mix the second local oscillator signal with an intermediate-frequency signal received by a millimeter wave module to form a millimeter wave signal, and mix the second local oscillator signal with a millimeter wave signal received by the millimeter wave module to form an intermediate-frequency signal.

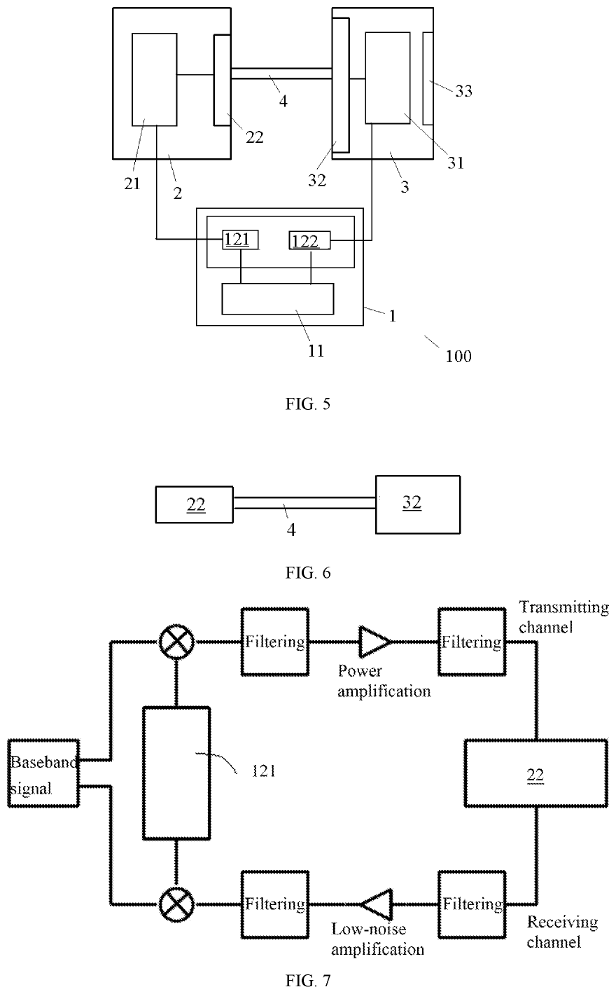

With reference to FIGS. 5 and 6, according to a fourth embodiment of the present disclosure, provided is a terminal 100. The terminal 100 is applicable to a millimeter wave terminal and includes a mainboard module 2, an intermediate-frequency transmission line 4, a millimeter wave module 3 and a local oscillator control system 1. The local oscillator control system 1 is the local oscillator control system 1 according to the third embodiment of the present disclosure.

The local oscillator control system 1 is configured to, when the mainboard module 2 receives a baseband signal, mix a first local oscillator signal with the baseband signal to form an intermediate-frequency signal; when the mainboard module 2 receives an intermediate-frequency signal, mix the first local oscillator signal with the received intermediate-frequency signal to form a baseband signal; when the millimeter wave module 3 receives an intermediate-frequency signal transmitted by the mainboard module 2, mix a second local oscillator signal with the intermediate-frequency signal to form a millimeter wave signal; and, when the millimeter wave module 3 receives a millimeter wave signal, mix the second local oscillator signal with the millimeter wave signal to form an intermediate-frequency signal.

In this embodiment, as shown in FIG. 5, the mainboard module 2 includes an intermediate-frequency transceiving unit 21 and a mainboard side connector 22. The millimeter wave module 3 includes a radio frequency transceiving unit 31, a millimeter wave module side connector 32, a switch control unit 34 and an antenna unit 33. As shown in FIG. 6, intermediate-frequency signals are transmitted between the mainboard side connector 22 and the millimeter wave module side connector 32 through the intermediate-frequency transmission line 4.

The intermediate-frequency transmission line 4 includes a coaxial cable, a flexible circuit board, and the like. The flexible circuit board may be made of a high-frequency flexible printed circuit board (FPC), a liquid crystal polymer (LCP), and the like.

In this embodiment, as shown in FIG. 7, when the intermediate-frequency transceiving unit 21 receives a baseband signal, the first sub-unit 121 mixes the first local oscillator signal with the baseband signal to form an intermediate-frequency signal. The first sub-unit 121 adjusts the frequency point of the first local oscillator signal under the control of the central control unit 11, so that the frequency point of the intermediate-frequency signal formed by frequency mixing will not interfere with the operating frequency band in the current scene.

The intermediate-frequency transceiving unit 21 filters the intermediate-frequency signal obtained after frequency mixing and then transmits the signal to the millimeter wave module side connector 21 through the mainboard side connector 22 and the intermediate-frequency transmission line 4. The intermediate-frequency transceiving unit 21 successively performs primary filtering, amplification and secondary filtering on the intermediate-frequency signal formed by mixing with the baseband signal.

When the mainboard side connector 22 receives the intermediate-frequency signal from the millimeter wave module side connector 32, the intermediate-frequency transceiving unit 21 filters the intermediate-frequency signal. The intermediate-frequency transceiving unit 21 successively performs primary filtering, amplification and secondary filtering on the intermediate-frequency signal received by the mainboard side connector 22.

The first sub-unit 121 mixes the filtered first local oscillator signal with the intermediate-frequency signal to form a baseband signal.

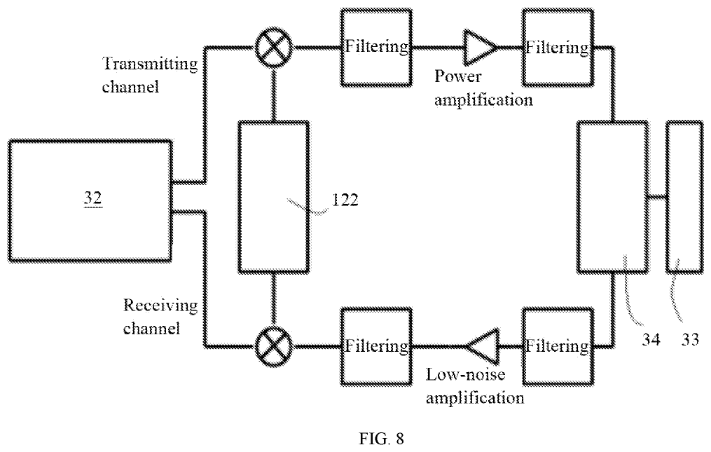

As shown in FIG. 8, when the millimeter wave module side connector 32 receives the intermediate-frequency signal transmitted by the mainboard side connector 22, the second sub-unit 122 mixes the second local oscillator with the intermediate-frequency signal to form a millimeter wave signal.

The radio frequency transceiving unit 31 filters the millimeter wave signal formed by frequency mixing, and then transmits the millimeter wave signal successively through the switch control unit 34 and the antenna unit 33. The radio frequency transceiving unit 31 successively performs primary filtering, amplification and secondary filtering on the millimeter wave signal.

When the antenna unit 33 receives the millimeter wave signal, the radio frequency transceiving unit 31 filters the millimeter wave signal. The radio frequency transceiving unit 31 successively performs primary filtering, low-noise amplification and secondary filtering on the millimeter wave signal.

The second sub-unit 122 mixes the second local oscillator signal with the millimeter wave signal to form an intermediate-frequency signal. The second sub-unit 12 adjusts the frequency point of the second local oscillator signal under the control of the central control unit 11, so that the frequency point of the intermediate-frequency signal formed by frequency mixing will not interfere with the operating frequency band in the current scene. The millimeter wave module side connector 32 transmits the intermediate-frequency signal obtained after frequency mixing to the mainboard side connector 22 through the intermediate-frequency transmission line 4.

In accordance with the terminal 100 provided in this embodiment, by adopting the local oscillator signal system 1 provided in the second embodiment, the frequency point of the local oscillator signal can be adaptively adjusted for different scenes to avoid interference between the intermediate-frequency signal matched with the local oscillator signal and the operating frequency band in the current scene.

As another technical scheme, this embodiment further provides a signal transceiving method. By taking transceiving signals by the terminal provided in the fourth embodiment as an example, as shown in FIG. 5, the signal transceiving method includes steps of: when a mainboard module 2 receives a baseband signal, mixing a first local oscillator signal with the baseband signal to form an intermediate-frequency signal; when the mainboard module 2 receives an intermediate-frequency signal, mixing the first local oscillator signal with the received intermediate-frequency signal to form a baseband signal; when the millimeter wave module 3 receiving an intermediate-frequency signal transmitted by the mainboard module 2, mixing a second local oscillator signal with the intermediate-frequency signal to form a millimeter wave signal; and, when the millimeter wave module 3 receives a millimeter wave signal, mixing the second local oscillator signal with the millimeter wave signal to form an intermediate-signal signal.

In the signal transceiving method provided in this embodiment, the frequency points of the first local oscillator signal and the second local oscillator signal are controlled by the local oscillator control method provided in the first embodiment.

In accordance with the signal transceiving method provided in this embodiment, by adopting the local oscillator control method provided in the first embodiment, the frequency point of the local oscillator signal can be adaptively adjusted for different scenes to avoid interference between the intermediate-frequency signal matched with the local oscillator signal and the operating frequency band in the current scene.

As another technical scheme, this embodiment of the present disclosure further provides a computer-readable storage medium configured to store executable programs which, when executed by a processor, cause the processor to carry out the local oscillator control method according to the embodiments of the present disclosure or the signal transceiving method according to the embodiments of the present disclosure.

The computer-readable storage medium includes volatile or non-volatile and removable or non-removable mediums implemented in any method or technology used to store information (such as computer-readable instructions, data structures, program modules or other data). The computer-readable storage medium includes, but not limited to, RAMs, ROMs, EEPROMs, flash memories or other memory technologies, CD-ROMs, digital video disks (DVDs) or other optical disk storages, magnetic cassettes, magnetic tapes, magnetic disk storages or other magnetic storage devices, or any other mediums which can be used to store desired information and can be accessed by computers.

In accordance with the non-transitory computer-readable storage medium according to this embodiment of the present disclosure, by evaluating whether interference presents between the operating frequency band in the current scene and the default frequency point of the millimeter wave intermediate-frequency signal, acquiring the new frequency point of the local oscillator signal matched with the interference-free frequency point of the intermediate-frequency signal when there is interference, and adjusting the frequency point of the local oscillator signal from the default frequency point to the new frequency point, dynamic adjustment of the frequency point of the local oscillator signal can be realized, so that the frequency point of the local oscillator signal can be adaptively adjusted for different scenes to avoid interference between the intermediate-frequency signal matched with the local oscillator signal and the operating frequency band in the current scene.

As another technical scheme, this embodiment of the present disclosure further provides an electronic device. The electronic device may include a storage module and one or more first processors.

The storage module has first application programs and/or second application programs stored thereon. The first application programs, when executed by the one or more first processors, cause the one or more first processors to carry out the local oscillator control method according to the embodiments of the present disclosure. The second application programs, when executed by the one or more first processors, cause the one or more first processors to carry out the signal transceiving method according to the embodiments of the present disclosure.

In accordance with the electronic device according to this embodiment of the present disclosure, by evaluating whether interference presents between the operating frequency band in the current scene and the default frequency point of the millimeter wave intermediate-frequency signal, acquiring the new frequency point of the local oscillator signal matched with the frequency point of the interference-free intermediate-frequency signal when interference presents, and adjusting the frequency point of the local oscillator signal from the default frequency point to the new frequency point, the dynamic adjustment of the frequency point of the local oscillator signal can be realized, so that the frequency point of the local oscillator signal can be adaptively adjusted for different scenes to avoid interference between the intermediate-frequency signal matched with the local oscillator signal and the operating frequency band in the current scene.

It should be understood that the foregoing implementations are merely exemplary embodiments used for explaining the principle of the present disclosure, and the present disclosure is not limited thereto. A person having ordinary skills in the art can make various variations and improvements without departing from the essence of the present disclosure, and those variations and improvements shall fall into the protection scope of the present disclosure.

1. A local oscillator control method, comprising:
in response to an operating resource of a scene being received and the operating resource containing a millimeter wave resource, extracting, from the operating resource, an operating frequency band in the scene;
evaluating whether interference presents between the operating frequency band and a default frequency point of a millimeter wave intermediate-frequency signal; and
in response to a presence of interference,
acquiring a new frequency point of a local oscillator signal matched with an interference-free frequency point of an intermediate-frequency signal, and
adjusting the frequency point of the local oscillator signal from a default frequency point of the local oscillator signal to the new frequency point.

2. The local oscillator control method of claim 1, further comprising:
preconfiguring an intermediate-frequency signal list, the intermediate-frequency signal list comprising the default frequency point of the millimeter wave intermediate-frequency signal, the default frequency point of the local oscillator signal and the new frequency point of the local oscillator signal matched with the interference-free frequency point of the intermediate-frequency signal in various scenes; and
in response to the presence of interference, acquiring a new frequency point of a local oscillator signal matched with an interference-free frequency point of an intermediate-frequency signal and adjusting the frequency point of the local oscillator signal from a default frequency point of the local oscillator signal to the new frequency point comprises:
in response to the presence of interference, selecting the new frequency point of the local oscillator signal matched with a current scene from the intermediate-frequency signal list, and
adjusting the frequency point of the local oscillator signal from the default frequency point to the new frequency point.

3. The local oscillator control method of claim 1, wherein the scene comprises a dual connection mode or a new radio carrier aggregation mode of a 4G radio access network and 5G new radio.

4. The local oscillator control method of claim 1, further comprising:
in response to an absence of interference, keeping the frequency point of the local oscillator signal as the default frequency point of the local oscillator signal.

5. A signal transceiving method, comprising:
in response to a mainboard module receiving a baseband signal, mixing a first local oscillator signal with the baseband signal to form an intermediate-frequency signal; and, in response to the mainboard module receiving an intermediate-frequency signal, mixing the first local oscillator signal with the received intermediate-frequency signal to form a baseband signal; and
in response to a millimeter wave module receiving an intermediate-frequency signal transmitted by the mainboard module, mixing a second local oscillator signal with the intermediate-frequency signal to form a millimeter wave signal; and, in response to the millimeter wave module receiving a millimeter wave signal, mixing the second local oscillator signal with the millimeter wave signal to form an intermediate-signal signal; and
wherein the frequency points of the first local oscillator signal and the second local oscillator signal are controlled by a local oscillator control method comprising:
in response to an operating resource of a scene being received and the operating resource containing a millimeter wave resource, extracting, from the operating resource, an operating frequency band in the scene;
evaluating whether interference presents between the operating frequency band and a default frequency point of a millimeter wave intermediate-frequency signal; and
in response to a presence of interference, acquiring a new frequency point of a local oscillator signal matched with an interference-free frequency point of an intermediate-frequency signal, and adjusting the frequency point of the local oscillator signal from a default frequency point of the local oscillator signal to the new frequency point.

6. A local oscillator control system, comprising a central control unit and a local oscillator control unit, wherein:
the central control unit is configured to: in response to an operating resource of a scene being received and the operating resource containing a millimeter wave resource, extract, from the resource, an operating frequency band in the scene, and evaluate whether interference presents between the operating frequency band and a default frequency point of a millimeter wave intermediate-frequency signal; and, in response to a presence of interference, acquire a new frequency point of a local oscillator signal matched with an interference-free frequency point of an intermediate-frequency signal, and control the local oscillator control unit to adjust the frequency point of the local oscillator signal from a default frequency point of the local oscillator signal to the new frequency point.

7. A terminal device, comprising a mainboard module, an intermediate-frequency transmission line, a millimeter wave module and the local oscillator control system of claim 6, wherein intermediate-frequency signals are transmitted between the mainboard module and the millimeter wave module through the intermediate-frequency transmission line; and
the local oscillator control system is configured to:
in response to the mainboard module receiving a baseband signal, mix a first local oscillator signal with the baseband signal to form an intermediate-frequency signal;
in response to the mainboard module receiving an intermediate-frequency signal, mix the first local oscillator signal with the received intermediate-frequency signal to form a baseband signal;
in response to the millimeter wave module receiving an intermediate-frequency signal transmitted by the mainboard module, mix a second local oscillator signal with the intermediate-frequency signal to form a millimeter wave signal; and,
in response to the millimeter wave module receiving a millimeter wave signal, mix the second local oscillator signal with the millimeter wave signal to form an intermediate-frequency signal.

8. The terminal of claim 7, wherein the intermediate-frequency transmission line comprises a coaxial cable or a flexible circuit board.

9. A non-transitory computer-readable storage medium configured to store executable programs which, when executed by a processor, cause the processor to carry out the local oscillator control method of claim 1.

10. An electronic device, comprising:
a storage module having first application programs and/or second application programs stored thereon, and
one or more first processors, wherein the first application programs, when executed by the one or more first processors, cause the one or more first processors to carry out the local oscillator control method of claim 1, and the second application programs, when executed by the one or more first processors, cause the one or more first processors to carry out the signal transceiving method of claim 5.

11. A non-transitory computer-readable storage medium configured to store executable programs which, when executed by a processor, cause the processor to carry out the signal transceiving method of claim 5.
